(19) United States
(12) Patent Application Publication
(10) Pub. No.: US 2024/0161771 A1
(43) Pub. Date: May 16, 2024

(54) INFORMATION PROCESSING SYSTEM, INFORMATION PROCESSING METHOD, AND NON-TRANSITORY COMPUTER READABLE RECORDING MEDIUM

(71) Applicant: Panasonic Intellectual Property Corporation of America, Torrance, CA (US)

(72) Inventors: Taketoshi NAKAO, Kyoto (JP); Toshiyuki MATSUMURA, Osaka (JP)

(73) Assignee: Panasonic Intellectual Property Corporation of America, Torrance, CA (US)

(21) Appl. No.: 18/421,511

(22) Filed: Jan. 24, 2024

Related U.S. Application Data
(63) Continuation of application No. PCT/JP2022/028075, filed on Jul. 19, 2022.

(30) Foreign Application Priority Data
Jul. 29, 2021 (JP) 2021-124570

(51) Int. Cl. G10L 25/93; G10L 21/10; G10L 25/27

(52) U.S. Cl. CPC G10L 25/93; G10L 21/10; G10L 25/27; G10L 2025/937

(57) ABSTRACT

In an information processing system, an estimation as to whether a sound collected by a microphone is steady sound or non-steady sound is executed, sound information estimated to indicate the non-steady sound is transmitted to a server as output sound information when it is estimated that it is the non-steady sound, and the server acquires the output sound information, and estimates an action of a person from a resulting output obtained by inputting the output sound information to a second trained model indicative of a relevance between the output sound information and action information on an action of a user.

### TECHNICAL FIELD

The present disclosure relates to a technique of estimating an action of a person from a sound.

### BACKGROUND ART

Recently, there has been a demand for estimation of an action of a user based on daily life noise that occurs in a house where the user lives to thereby provide various services adapted to a lifestyle of the user.

For example, Patent Literature 1 discloses an action estimation device that classifies a sound detected by a microphone as television sound or actual environmental sound, specifies the source of a sound classified as the actual environmental sound, and estimates an action of a user in a house on the basis of a result of the specification.

However, since no consideration can be seen in the technique of Patent Literature 1 for using the action estimation device in a network environment such as a cloud network, further improvement is required to reduce a load on a network.

### CITATION LIST

### Patent Literature

Patent Literature 1: Japanese Unexamined Patent Publication No. 2019-95517

### SUMMARY OF INVENTION

The present disclosure has been made to solve the above-mentioned problems, and to provide a technique that enables reduction of a load on a network.

An information processing system according to an aspect of the present disclosure includes a terminal and a computer connected with each other via a network, wherein the terminal includes: a sound collector that collects a sound; and a first estimator that inputs sound information indicative of the collected sound to a first trained model to estimate whether the sound indicated by the sound information is steady sound or non-steady sound, and outputs to the computer via the network the sound information estimated to indicate the non-steady sound as output sound information when the sound information is estimated to indicate the non-steady sound, and the computer includes: an acquisition part that acquires the output sound information; and a second estimator that estimates an action of a person from a resulting output obtained by inputting the output sound information acquired by the acquisition part to a second trained model indicative of a relevance between the output sound information and action information on an action of a person.

The present disclosure enables reduction of a load on a network that connects a terminal and a computer.

### BRIEF DESCRIPTION OF DRAWINGS

FIG. 1 is a block diagram showing an exemplary structure of an information processing system according to a first embodiment of the present disclosure.

FIG. 2 is a diagram representing machine learning for an autoencoder constituting a first trained model.

FIG. 3 is a diagram representing an estimation by the autoencoder constituting the first trained model.

FIG. 4 is a graph of first exemplary image information indicative of a spectrogram.

FIG. 5 is a graph of first exemplary image information indicative of a frequency response.

FIG. 6 is a graph of second exemplary image information indicative of a spectrogram.

FIG. 7 is a graph of second exemplary image information indicative of a frequency response.

FIG. 8 is a graph of third exemplary image information indicative of a spectrogram.

FIG. 9 is a graph of third exemplary image information indicative of a frequency response.

FIG. 10 is a graph of fourth exemplary image information indicative of a spectrogram.

FIG. 11 is a graph of fourth exemplary image information indicative of a frequency response.

FIG. 12 is a diagram representing machine learning for a convolutional neural network constituting a second trained model.

FIG. 13 is a diagram representing an estimation by the convolutional neural network constituting the second trained model.

FIG. 14 is a flowchart showing an exemplary process of the information processing system according to the first embodiment of the present disclosure.

FIG. 15 is a flowchart showing an exemplary setting process of a threshold used in a determination by a terminal of steady sound or non-steady sound.

FIG. 16 is a flowchart showing an exemplary process of the information processing system in transmission by a server of a control signal to a device.

FIG. 17 is a flowchart showing an exemplary process of retraining the first trained model.

FIG. 18 is a flowchart showing an exemplary process of retraining the second trained model.

FIG. 19 is a block diagram showing an exemplary structure of an information processing system according to a second embodiment of the present disclosure.

FIG. 20 is a diagram for explaining a frequency conversion.

FIG. 21 is a flowchart showing in detail an exemplary process in Step S14 in FIG. 14 in the second embodiment of the present disclosure.

FIG. 22 is a block diagram showing an exemplary structure of an information processing system according to a third embodiment of the present disclosure.

FIG. 23 is a block diagram showing an exemplary structure of an information processing system according to a fourth embodiment of the present disclosure.

FIG. 24 is a diagram for explaining a third modification of the present disclosure.

FIG. 25 is a diagram for explaining a fourth modification of the present disclosure.

### DESCRIPTION OF EMBODIMENTS

Underlying Findings for Present Disclosure

An application of a technique of estimating an action of a user from a sound collected in a house to a network system including a cloud server or the like has been considered, for example, as a structure in which sound information indicative of a sound collected in a house is transmitted to a server connected via a network and an estimation of an action based on the sound information is executed in the server.

In a house, some ambient sounds always occur or silence prevails, and a sound resulting from an action by a user tends to occur less frequently in comparison with the ambient sounds or the silence. Therefore, it is not necessary to use all of the sounds that have occurred in the house for the estimation of the action.

Further, since a sound in the hearing range collected in a house is susceptible to various noises, it cannot be said that an action of a person can be estimated with high accuracy therefrom. Therefore, use of a sound in an ultrasonic band that is not susceptible to the noises for the estimation of the action has been considered.

An application of an estimation of an action based on an ultrasonic band to the network environment described above makes the amount of data transmitted to the network much larger than that in a case of one based only on the audible sounds, and causes a large load on the network, for the ultrasonic band is wider than the hearing range, which results in the large amount of data, and the ultrasonic band represents a higher frequency than the hearing range, which requires setting a shorter sampling period.

The present inventors found that a two-phase structure for an estimation of an action including a terminal and a computer connected to the terminal via a network, in which only non-steady sound that is different from steady sound which always occurs is output to the computer from the terminal, and the computer executes an estimation of an action based on the non-steady sound, enables reduction of a load on the network and loads on the terminal and the computer, thus working out the present disclosure.

(1) An information processing system according to an aspect of the present disclosure includes a terminal and a computer connected with each other via a network, wherein the terminal includes: a sound collector that collects a sound; and a first estimator that inputs sound information indicative of the collected sound to a first trained model to estimate whether the sound indicated by the sound information is steady sound or non-steady sound, and outputs to the computer via the network the sound information estimated to indicate the non-steady sound as output sound information when the sound information is estimated to indicate the non-steady sound, and the computer includes: an acquisition part that acquires the output sound information; and a second estimator that estimates an action of a person from a resulting output obtained by inputting the output sound information acquired by the acquisition part to a second trained model indicative of a relevance between the output sound information and action information on an action of a person.

In this configuration, sound information indicative of a sound collected by the sound collector is input to the first trained model to estimate whether the sound is steady sound or non-steady sound, sound information indicative of the non-steady sound is output as output sound information from the terminal to the computer via the network when the sound is estimated to be the non-steady sound, and an action of a person is estimated from the output sound information by the computer.

Thus, in this configuration, the terminal does not output all of the sound information on the sounds collected by the sound collector to the computer, but outputs only the sound information indicative of the non-steady sound to the computer. Therefore, the amount of data moving across the network decreases, and the load on the network can be reduced.

(2) In the information processing system described in (1) above, the output sound information may be image information indicative of a spectrogram or frequency response of the sound collected by the sound collector.

In this configuration, the sound information output by the first estimator is image information indicative of a spectrogram or frequency response of the sound. Thus, the amount of data of the sound information output to the network can be greatly reduced in comparison with a case where chronological data of sound pressure of a sound collected by the sound collector is transmitted.

(3) In the information processing system described in (1) above, the first estimator may extract, from the sound information estimated to indicate the non-steady sound, sound information in a first frequency band having a highest sound pressure level, and convert the extracted sound information in the first frequency band to sound information in a second frequency band lower than the first frequency band, the converted sound information in the second frequency band being generated as the output sound information.

In this configuration, sound information in a first frequency band is extracted from the sound information indicative of the non-steady sound, the extracted sound information is converted to sound information in a second frequency band lower than the first frequency band, and the converted sound information in the second frequency band is output as the output sound information from the terminal to the computer. Thus, the amount of data of the output sound information transmitted to the network can be greatly reduced in comparison with a case where chronological data of sound pressure of a sound collected by the sound collector is transmitted.

(4) In the information processing system described in (3) above, the output sound information may have accompanying information indicative of a width of the first frequency band.

In this configuration, accompanying information indicative of the first frequency band is output from the terminal to the computer together with the sound information in the second frequency band. Thus, the computer can specify the first frequency band by using the accompanying information. Consequently, the accuracy in the estimation of the action can be improved.

(5) In the information processing system described in (3) or (4) above, the second trained model may have learned by machine learning a relevance between the sound information in the second frequency band and having the accompanying information and the action information.

In this configuration, the second trained model has learned by machine learning a relevance between the sound information in the second frequency band and having the accompanying information and the action information. Thus, an action of a person can be estimated with high accuracy by use of the accompanying information and the sound information in the second frequency band.

(6) In the information processing system described in any one of (3) to (5) above, the first frequency band may be an ultrasonic band that has a highest sound pressure level among a plurality of predetermined frequency bands.

In this configuration, sound information in an ultrasonic band that concerns the non-steady sound the most largely among the plurality of predetermined frequency bands is extracted as the sound information in the first frequency band. Thus, the sound information in the first frequency band can be easily extracted.

(7) In the information processing system described in any one of (1) to (6) above, the first estimator may estimate the sound indicated by the sound information to be the non-steady sound when an estimation error of the first trained model is not less than a threshold, and change the threshold such that a frequency of estimations of the non-steady sound is not greater than a reference frequency.

In this configuration, the threshold for the estimation error of the first trained model is changed such that the frequency of estimations of the non-steady sound is not greater than a reference frequency. Thus, the load on the network can be further reduced.

(8) The information processing system described in any one of (1) to (7) above may further include a determination part that determines whether or not the resulting output from the second trained model is wrong, and inputs determination result information indicative of a result of the determination to the second estimator, and the second estimator may retrain, when receiving an input of determination result information indicating that a resulting output is correct, the second trained model using output sound information corresponding to the resulting output.

In this configuration, when determination result information indicating that a resulting output from the second trained model is correct is input, the second trained model is retrained by use of output sound information corresponding to the resulting output. Thus, the accuracy in estimation by the second trained model can be improved.

(9) In the information processing system described in (8) above, the determination part may input to a device a control signal of controlling the device according to the action information indicative of the action estimated by the second estimator, and determine that the resulting output is wrong when receiving from the device a cancellation order of the control indicated by the control signal.

In this configuration, the resulting output from the second trained model is determined to be wrong when a cancellation order of the control is acquired from the device. Thus, it can be easily determined whether or not a resulting output is wrong.

(10) In the information processing system described in (8) or (9) above, the second estimator may output, when receiving an input of the determination result information, the determination result information to the terminal via the network.

This configuration enables provision for the terminal of feedback that is a determination result indicating whether or not an action has been estimated correctly on the basis of sound information corresponding to a resulting output from the second trained model.

(11) In the information processing system described in any one of (1) to (10) above, the first estimator may retrain the first trained model by using the sound information estimated to indicate the steady sound by the first trained model.

In this configuration, the first trained model is retrained by use of the sound information estimated to indicate the steady sound. Thus, the accuracy in estimation by the first trained model can be improved.

(12) In the information processing system described in any one of (1) to (11) above, the sound information may concern sound information on an ambient sound in a space where the sound collector is disposed.

This configuration enables estimation of an action of a user in a space where the sound collector is disposed.

(13) In the information processing system described in any one of (1) to (12) above, the sound information acquired by the sound collector may include a sound in an ultrasonic band.

In this configuration, an action of the user is estimated by use of the sound information in the ultrasonic band. Thus, the accuracy in estimation of an action of a user can be improved. Further, the amount of data of the sound information in the ultrasonic band is much larger than that of the sound information in the hearing range; however, in this configuration, only the non-steady sound is output from the terminal to the computer; thus, the load on the network and the loads on the terminal and the computer can be reduced.

(14) In the information processing system described in any one of (1), and (7) to (13) above, the first estimator may extract, from the sound information estimated to indicate the non-steady sound, sound information in a plurality of first frequency bands, convert the extracted sound information in the first frequency bands to sound information in a second frequency band that is the lowest first frequency band among the first frequency bands, and synthesize the converted sound information pieces in the second frequency band, the synthesized sound information being generated as the output sound information.

In this configuration, sound information estimated to indicate the non-steady sound that results from compression by frequency conversion is output to the computer. Thus, the amount of data moving across the network can be further reduced.

(15) In the information processing system described in any one of (1), and (7) to (13) above, the first estimator may extract, from the sound information estimated to indicate the non-steady sound, sound information in a first frequency band concerning the non-steady sound among a plurality of first frequency bands, convert the extracted sound information in the first frequency band to sound information in a second frequency band that is the lowest first frequency band among the first frequency bands, and synthesize the converted sound information in the second frequency band, the synthesized sound information being generated as the output sound information.

In this configuration, sound information in a first frequency band concerning the non-steady sound is extracted, and the extracted sound information is compressed into that in the second frequency band to be transmitted to the computer. Thus, the amount of data moving across the network can be further reduced.

(16) An information processing method according to another aspect of the present disclosure for use in an information processing system including a terminal and a computer connected to each other via a network, includes: by the terminal, collecting a sound; inputting sound information indicative of the collected sound to a first trained model to estimate whether the sound indicated by the sound information is steady sound or non-steady sound; and outputting to the computer via the network the sound information estimated to indicate the non-steady sound as output sound information when the sound information is estimated to indicate the non-steady sound, and by the computer, acquiring the output sound information; and estimating an action of a person from a resulting output obtained by inputting the acquired output sound information to a second trained model indicative of a relevance between the output sound information and action information on an action of a person.

This configuration enables provision of an information processing method that exerts the same advantageous effects as those described for the information processing system.

(17) An information processing program according to still another aspect of the present disclosure for use in an information processing system including a terminal and a computer connected to each other via a network, causes the terminal to execute a process of: collecting a sound; inputting sound information indicative of the collected sound to a first trained model to estimate whether the sound indicated by the sound information is steady sound or non-steady sound; and outputting to the computer via the network the sound information estimated to indicate the non-steady sound as output sound information when the sound information is estimated to indicate the non-steady sound, and causes the computer to execute a process of: acquiring the output sound information; and estimating an action of a person from a resulting output obtained by inputting the acquired output sound information to a second trained model indicative of a relevance between the output sound information and action information on an action of a person.

It goes without saying that the information processing program in the present disclosure is distributable as a non-transitory computer readable storage medium like a CD-ROM, or distributable via a communication network like the Internet.

Each of the embodiments which will be described below represents a specific example of the disclosure. Numerical values, shapes, constituents, steps, and the order thereof described below are mere examples, and thus should not be construed to delimit the disclosure. Further, constituents which are not recited in the independent claims each showing the broadest concept among the constituents in the embodiments are described as selectable constituent. The respective contents are combinable with each other in all the embodiments.

### First Embodiment

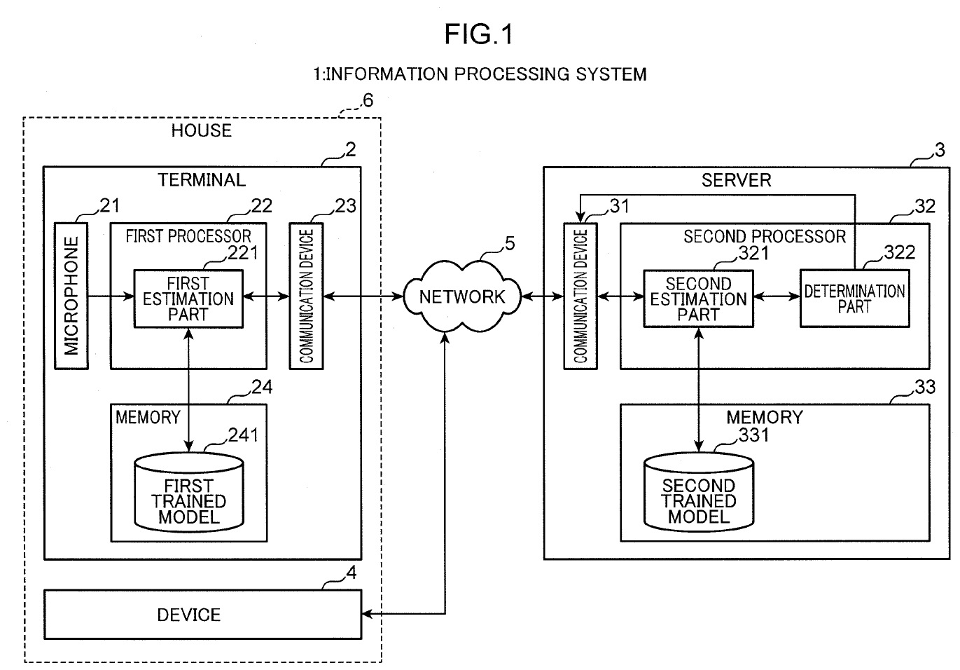

FIG. 1 is a block diagram showing an exemplary structure of an information processing system 1 according to a first embodiment of the present disclosure. The information processing system 1 includes a terminal 2 and a server 3 (an exemplary computer). The terminal 2 is disposed in a house 6 where a user lives whose action is estimated. The terminal 2 and the server 3 are communicably connected with each other via a network 5. The terminal 2 is disposed in, e.g., a corridor, a stairway, an entrance, or a room of the house 6. The room is, e.g., a dressing room, a kitchen, a closet, a living room, or a dining room.

The network 5 is, e.g., a public communication line including the Internet and a mobile phone communication network. The server 3 is, e.g., a cloud server provided in the network 5. The house 6 is provided with a device 4, which operates on the basis of a control signal according to an action of the user estimated by the server 3.

The terminal 2 and the device 4 are described as being disposed in the house 6, which is merely an example, and may be disposed in a facility such as a factory or an office.

The terminal 2 is, e.g., a desktop computer. The terminal 2 includes a microphone 21 (an exemplary sound collector), a first processor 22 (an exemplary first estimator), a communication device 23, and a memory 24.

The microphone 21 is sensitive to, e.g., a sound (audible sound) in a hearing range and a sound (inaudible sound) in an ultrasonic band. Thus, the microphone 21 collects the audible sound and the inaudible sound. The hearing range is, e.g., 0 to 20 kHz. The inaudible sound is a sound in a frequency band of 20 kHz or more. The microphone 21 may be a microphone that is sensitive only to the sound in the ultrasonic band. The microphone 21 is, e.g., a micro electronics mechanical system (MEMS) microphone. The microphone 21 collects the audible sound and the inaudible sound resulting from an action of a user (an exemplary person) present in the house 6. Since various objects other than the user exist in the house 6, the microphone 21 collects various sounds resulting from interactions between the user and these objects. The microphone 21 generates a sound signal by converting a collected sound to an electrical signal, and inputs the generated sound signal to a first estimation part 221.

The object existing in the house 6 is, e.g., a home installation, a home appliance, furniture, or a household item. The home installation is, e.g., a faucet, a shower, a stove, a window, or a door. The home appliance is, e.g., a washing machine, a dishwasher, a vacuum cleaner, an air conditioner, a blower, a lighting device, a hair dryer, or a television. The furniture is, e.g., a desk, a chair, or a bed. The household item is, e.g., a trash can, a storage box, an umbrella stand, or pet products.

The first processor 22 is constituted by, e.g., a central processing unit, and includes the first estimation part 221. The first estimation part 221 does performance when the central processing unit executes an information processing program. However, this configuration is merely an example, and the first estimation part 221 may be constituted by dedicated hardware, e.g., an ASIC.

The first estimation part 221 inputs sound information indicative of a sound collected by the microphone 21 to a first trained model 241 to thereby estimate whether the sound indicated by the sound information is steady sound or non-steady sound; generates, in a case of an estimation of the non-steady sound, output sound information for outputting the sound information estimated to indicate the non-steady sound; and outputs the generated output sound information to the server 3 through the communication device 23. The first trained model 241 is a trained model created in advance to estimate whether a sound indicated by sound information is the steady sound or the non-steady sound. The first trained model 241 is, e.g., an autoencoder.

The sound information has digital data of sound pressure resulting from AD conversion at a predetermined sampling period and arrayed chronologically in a certain time length. The first estimation part 221 repeats the process of generating the sound information while receiving an input of a sound signal from the microphone 21. The sound signal to be input may include a sound signal that represents the silence.

The steady sound includes an ambient sound that always occurs in the house 6. The ambient sound is, e.g., a vibration sound of a home installation or a home appliance that continuously operates. The ambient sound is, for example, a vibration sound of a refrigerator. The non-steady sound is a sound that occurs less frequently than the steady sound, and includes a sound that results from an action of a person. The non-steady sound is, for example, a sound generated by opening or closing a door of a refrigerator, a sound generated by the user walking on a corridor, a sound of water flowing out of a faucet, a rubbing sound of clothes, or a sound generated by the user combing the hair.

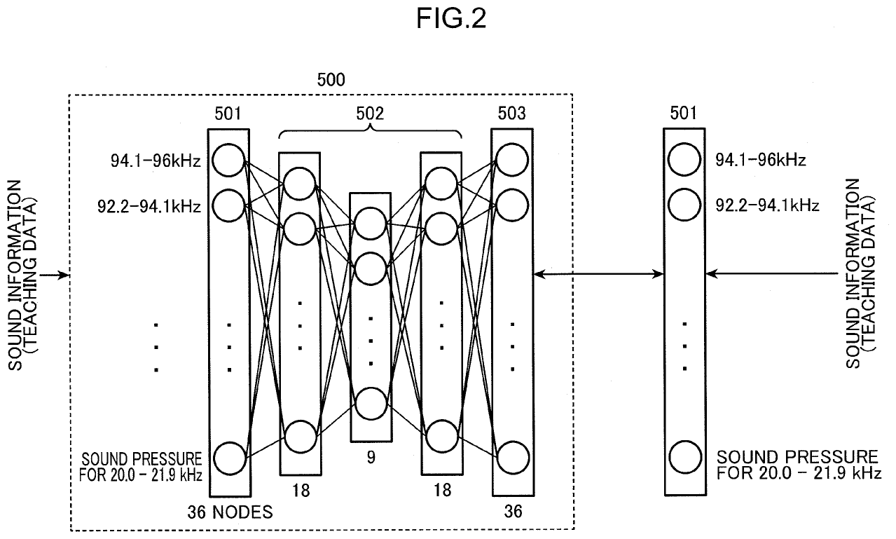

FIG. 2 is a diagram representing machine learning for an autoencoder 500 constituting the first trained model 241. In the example of FIG. 2, the autoencoder 500 includes an input layer 501, an intermediate layer 502, and an output layer 503. In the example of FIG. 2, the intermediate layer 502 has three layers, and the autoencoder 500 consists of five layers in total, but this is merely an example. The number of intermediate layers 502 may be one, or four or more.

The input layer 501 and the output layer 503 each have 36 nodes. The first and the third intermediate layers 502 each have 18 nodes. The second intermediate layer 502 has 9 nodes. The 36 nodes of each of the input layer 501 and the output layer 503 are associated with 36 frequency bands obtained by separating a frequency band from 20 kHz to 96 kHz by 1.9 kHz. Specifically, the respective nodes of each of the input layer 501 and the output layer 503 are associated with the frequency bands of 94.1 to 96 kHz, 92.2 to 94.1 kHz, . . . , 20.0 to 21.9 kHz from the top node. Each node of the input layer 501 takes an input of data of sound pressure for the associated frequency band serving as the sound information, and each node of the output layer 503 gives an output of data of sound pressure for the associated frequency band serving as the sound information.

Exemplary teaching data used in the machine learning for the autoencoder 500 is sound information indicative of the steady sound collected in the house 6 in advance.

The dimension of the sound information indicative of the steady sound input to each node of the input layer 501 is gradually reduced through the first intermediate layer 502 and the second intermediate layer 502, and is restored through the third intermediate layer 502 and the output layer 503. The autoencoder 500 is trained by machine learning such that data of sound pressure output from each node of the output layer 503 is equal to data of sound pressure input to each node of the input layer 501. The autoencoder 500 is trained by machine learning by use of a large amount of the sound information indicative of the steady sound. The number of nodes in each layer shown in FIG. 2 is not limited to the number described above; the number may vary. Further, each value for the frequency band associated with the input layer 501 and the output layer 503 is not limited to the value described above; the value may vary. The memory 24 stores the trained model 241 created in advance by the machine learning.

The trained model 241 constituted by an autoencoder 500 was described, but the present disclosure is not limited to this. Any machine learning model that can be trained by machine learning for the steady sound may be used. Another exemplary trained model 241 is a convolutional neural network (CNN).

In a case where the first trained model 241 is constituted by the convolutional neural network, machine learning is executed after sound information indicative of the steady sound is assigned with a label of the steady sound and sound information indicative of the non-steady sound is assigned with a label of the non-steady sound.

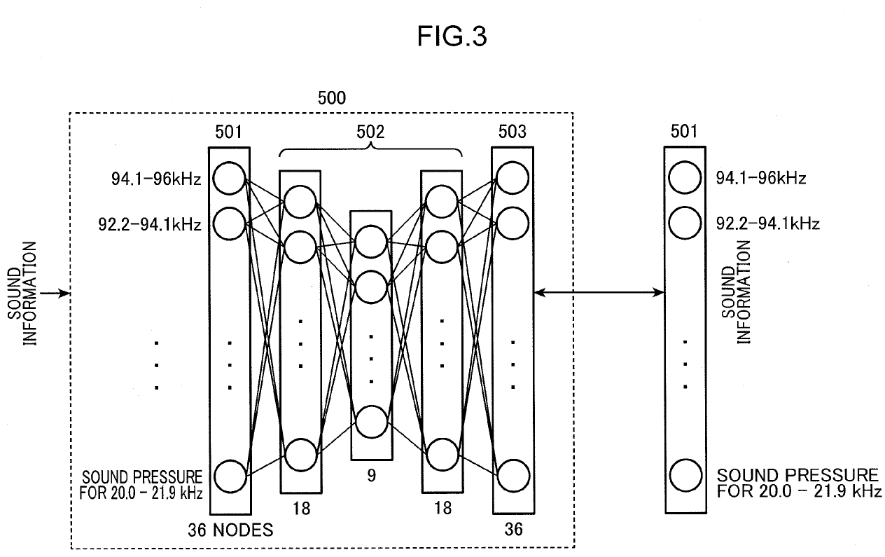

FIG. 3 is a diagram representing an estimation by the autoencoder 500 constituting the first trained model 241. The first estimation part 221 converts the input sound information of the time domain to sound information of the frequency domain by Fourier transform. The first estimation part 221 then separates the sound information of the frequency domain according to the frequency bands associated with the respective nodes of the input layer 501, and inputs the sound information (data of sound pressure) separated according to the frequency bands to each node. The first estimation part 221 then calculates an estimation error between the sound information output from each node of the output layer 503 and the sound information input to each node of the input layer 501. The estimation error is, e.g., the cross-entropy loss. The first estimation part 221 then determines whether the estimation error is not less than a threshold. The first estimation part 221 determines that the input sound information indicates the non-steady sound when the estimation error is not less than the threshold, and determines that the input estimation error indicates the steady sound when the estimation error is less than the threshold. The estimation error is not limited to the cross-entropy loss, and may be the mean squared error, the mean absolute error, the root mean squared error, or the mean squared logarithmic error.

In a case where the first trained model 241 is the convolutional neural network, the output layer has, e.g., a first node that is associated with the steady sound and constituted by a softmax function and a second node that is associated with the non-steady sound and constituted by the softmax function. The first estimation part 221 estimates that a sound is the steady sound when an output value of the first node is larger than an output value of the second node, and estimates that a sound is the non-steady sound when the output value of the second node is larger than the output value of the first node.

With reference to FIG. 1, the first estimation part 221 generates, when estimating that the input sound information indicates the non-steady sound, image information indicative of a feature of the sound information as output sound information. The image information is, e.g., image information indicative of a spectrogram or image information indicative of a frequency response. The image information indicative of the spectrogram is, for example, an image of a two-dimensional coordinate space having one coordinate axis representing the time and the other coordinate axis representing the frequency, which shows data of sound pressure in a frequency domain according to time variation in grayscale. The image information indicative of the frequency response is an image obtained by performing Fourier transform of the sound information. Specifically, the image information indicative of the frequency response is, for example, image information indicative of a two-dimensional coordinate space having one coordinate axis representing the frequency and the other axis representing the data of sound pressure, the two-dimensional coordinate space including one area surrounded by a waveform representing a frequency spectrum and the other area, the areas consisting of respective pixels having different pixel values.

The first to fourth exemplary image information will be described below.

### First Example

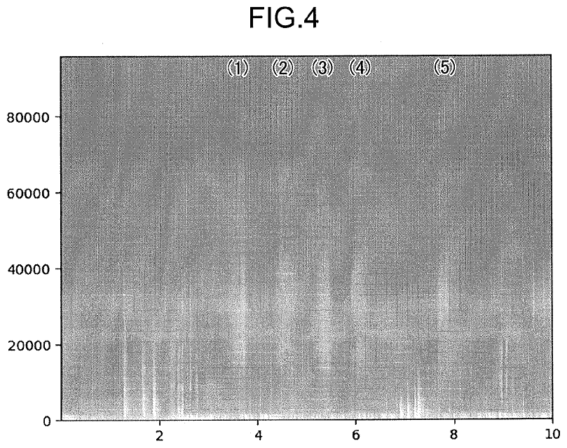

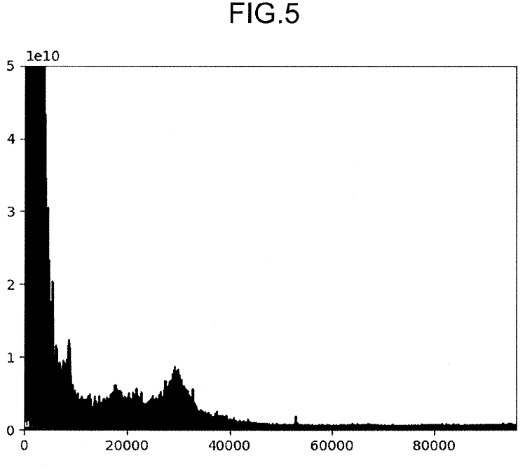

FIGS. 4 and 5 are graphs of first exemplary image information; FIG. 4 represents image information indicative of a spectrogram, and FIG. 5 represents image information indicative of a frequency response. The first exemplary image information indicates a feature of a sound generated when a person takes on or off clothes. In the first example, the clothes are made of cotton.

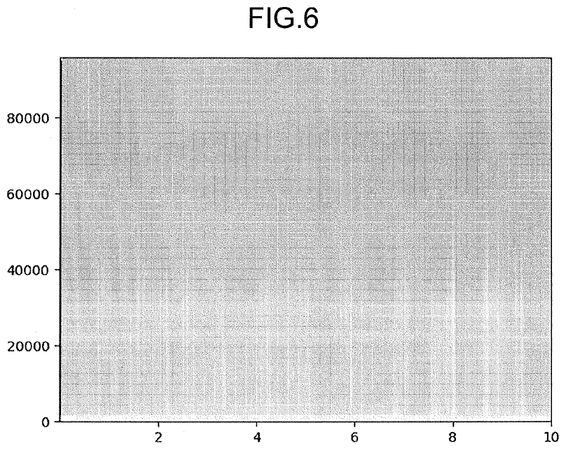

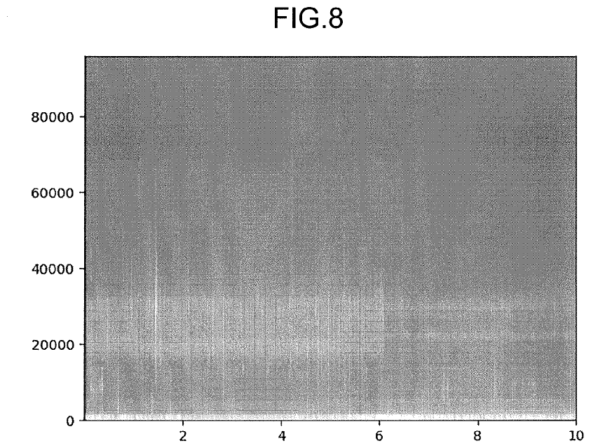

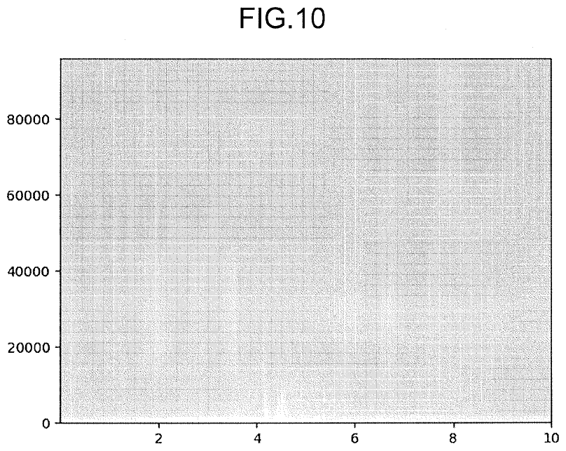

In FIG. 4, the horizontal axis represents the time (second) and the vertical axis represents the frequency (Hz), and each pixel has a pixel value corresponding to the data of sound pressure, which also applies to FIG. 6, FIG. 8, and FIG. 10.

FIG. 4 shows five detected distinctive signals (1) to (5) in the frequency band of 20 kHz or more. The signals (1) and (2) indicate more than 80 kHz, the signals (3) and (4) indicate a little less than 80 kHz, and the signal (5) indicates a little less than 70 kHz. Each signal indicates high intensity particularly in 50 kHz or less. These signals correspond to a rubbing sound of clothes generated when a person takes on or off the clothes.

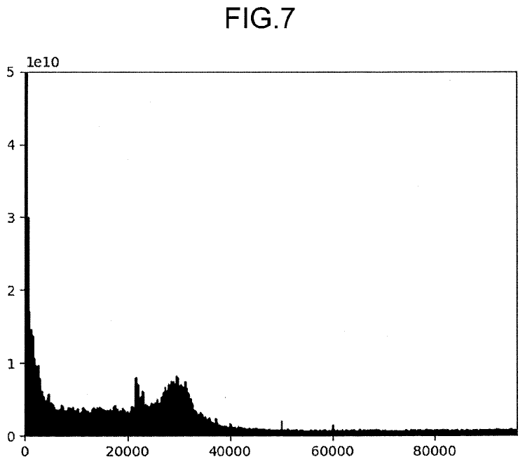

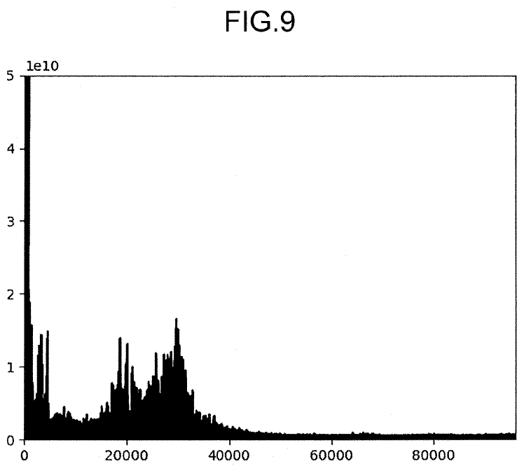

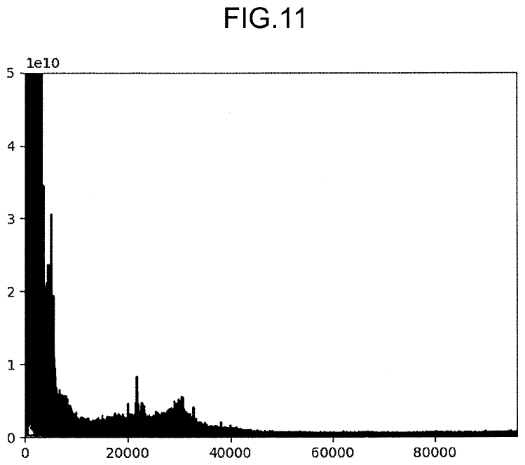

In FIG. 5, the horizontal axis represents the frequency (Hz) and the vertical axis represents the intensity of sound pressure, which also applies to FIG. 7, FIG. 9, and FIG. 11. In FIG. 5, the frequency component in a frequency band from 20 kHz to 50 kHz of the frequency component from 20 kHz indicates high intensity.

The action estimated from the first exemplary image information is, e.g., “undressing” or “cloth changing”.

### Second Example

FIGS. 6 and 7 are graphs of second exemplary image information; FIG. 6 represents image information indicative of a spectrogram, and FIG. 7 represents image information indicative of a frequency response. The second exemplary image information indicates a feature of a sound generated when a person walks on a wooden corridor. Specifically, the second exemplary image information indicates the feature of the sound generated when the person walks on the corridor barefoot.

FIG. 6 shows a detected signal corresponding to a rubbing sound between the corridor and the feet generated when the person walks on the corridor barefoot.

For example, distinctive signals in a frequency band from 20 kHz to 50 kHz, particularly from 20 kHz to 35 kHz, are detected for the barefoot walking on the corridor by the person.

In FIG. 7, the frequency component in a frequency band from 20 kHz to 40 kHz of the frequency component from 20 kHz indicates high intensity.

The action estimated from the second exemplary image information is, e.g., “walking”.

### Third Example

FIGS. 8 and 9 are graphs of third exemplary image information; FIG. 8 represents image information indicative of a spectrogram, and FIG. 9 represents image information indicative of a frequency response. The third exemplary image information indicates a feature of a sound generated when a little water is made to flow out of a faucet.

FIG. 8 shows a signal corresponding to a sound of the flowing water, detected between 0 seconds and 6 seconds. A consecutive signal is detected between around 20 kHz and around 35 kHz, and signals over 40 kHz are detected in the consecutive signal.

In the image information indicative of the frequency response in FIG. 9, the frequency component in a frequency band from around 20 kHz to 35 kHz of the frequency component from 20 kHz indicates high intensity.

The action estimated from the third exemplary image information is, e.g., “handwashing”.

### Fourth Example

FIGS. 10 and 11 are graphs of fourth exemplary image information; FIG. 10 represents image information indicative of a spectrogram, and FIG. 11 represents image information indicative of a frequency response. The fourth exemplary image information indicates a feature of an inaudible sound generated in combing the hair.

FIG. 10 shows a detected distinctive signal in a frequency band from 20 kHz to 60 kHz.

In the image information indicative of the frequency response in FIG. 11, the frequency component in a frequency band from 20 kHz to 50 kHz of the frequency component from 20 kHz indicates high intensity.

The action estimated from the fourth exemplary image information is, e.g., “hair combing”.

Since the first estimation part 221 outputs the image information as described in the first to fourth examples to the server 3 as the output sound information, the amount of data can be greatly reduced in comparison with the case where chronological data of sound pressure is output. A transmission of the chronological data of sound pressure may cause the amount of data to be in the order of tens of megabytes, but an output of the image information can reduce the amount of data to not larger than hundreds of kilobytes, i.e., to around 1/100.

With reference to FIG. 1, the first estimation part 221 accumulates in the memory 24 the sound information input to the first trained model 241 in association with the estimation result, and regularly retrains the first trained model 241 using the accumulated sound information.

Further, the first estimation part 221 changes the threshold such that a frequency of estimations by the first trained model 241 of the non-steady sound is not greater than a reference frequency.

The communication device 23 is a communication circuit that connects the terminal 2 to the network 5. The communication device 23 transmits the output sound information to the server 3, and receives determination result information described later from the server 3. For example, the communication device 23 transmits the output sound information using a certain communication protocol, e.g., Message Queuing Telemetry Transport (MQTT).

The memory 24 is, for example, a rewritable non-volatile semiconductor memory such as a flash memory, and stores the first trained model 241 and the sound information subject to the estimation by the first trained model 241.

The configuration of the terminal 2 is as described above. Next, the configuration of the server 3 will be described. The server 3 includes a communication device 31 (an exemplary acquisition part), a second processor 32, and a memory 33. The communication device 31 is a communication circuit that connects the server 3 to the network 5. The communication device 31 receives the output sound information from the terminal 2, and receives the determination result information described later from the server 3.

The second processor 32 is constituted by, e.g., a central processing unit, and includes a second estimation part 321 (an exemplary second estimator) and a determination part 322. The second estimation part 321 and the determination part 322 do performance when the central processing unit executes a certain information processing program. However, this configuration is merely an example, and the second estimation part 321 and the determination part 322 may be constituted by dedicated hardware, e.g., an ASIC.

The second estimation part 321 estimates an action of the user from a resulting output obtained by inputting the output sound information to a second trained model 331.

The second trained model 331 is a model that has been trained by machine learning with teaching data which is one or more datasets including a set of output sound information and action information on an action of a person associated with the output sound information. The output sound information is image information indicative of the spectrogram or frequency response as described above. An exemplary data format for the image information is Joint Photographic Experts Group (JPEG) or Basic Multilingual Plane (BMP). The output sound information may be sound information consisting of chronological data of sound pressure with a certain time length; in this case, the teaching data for the second trained model 331 is one or more datasets of sound information and action information, and an exemplary data format for the sound information is Waveform Audio File Format (WAV).

An exemplary second trained model 331 is a convolutional neural network, a recurrent neural network (RNN) such as a long short term memory (LSTM), or an attention mechanism.

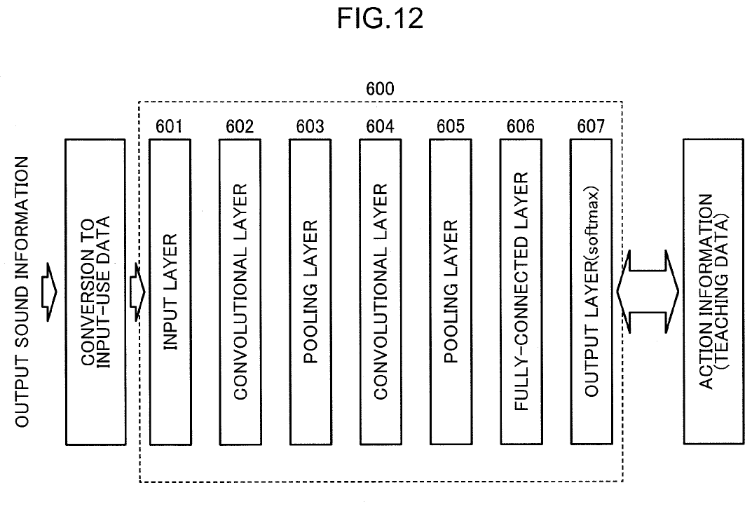

FIG. 12 is a diagram representing machine learning for a convolutional neural network 600 constituting the second trained model 331. The convolutional neural network 600 includes an input layer 601, a convolutional layer 602, a pooling layer 603, a convolutional layer 604, a pooling layer 605, a fully-connected layer 606, and an output layer 607. Since the convolutional neural network 600 is well-known, the detailed description thereof will be omitted. The nodes constituting the output layer 607 are each associated with respective actions to be estimated, and constituted by, e.g., a softmax function.

The output sound information is converted to input-use data, which is input to the input layer. The input-use data is, for example, data of a linear array of each pixel value for the image information indicative of the spectrogram or frequency response. Each pixel value included in the input-use data is input to each node of the input layer 601. The input-use data input to the input layer 601 is processed sequentially through each layer (602 to 607) to be output from the output layer 607. The resulting output from the output layer 607 is compared with the action information in the teaching data; an error between the resulting output and the teaching data is calculated by use of a loss function; the convolutional neural network 600 is trained by machine learning so as to minimize the calculated error.

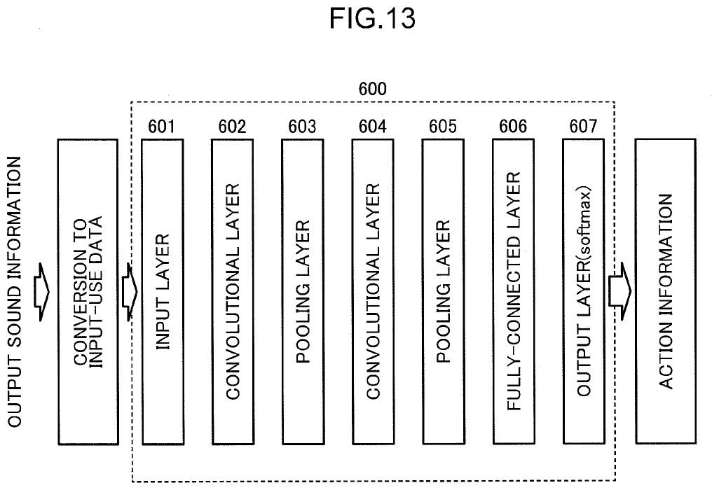

FIG. 13 is a diagram representing an estimation by the convolutional neural network 600 constituting the second trained model 331. The second estimation part 321 converts the output sound information output from the terminal 2 to input-use data, which is input to each node of the input layer 601. The input-use data input to the input layer 601 is processed sequentially through each layer (602 to 607) to be output from the output layer 607. The second estimation part 321 estimates an action of the user from the action associated with the node that outputs the highest output value among the respective output values of the nodes output from the output layer 607. The estimated action is, e.g., “undressing”, “cloth changing”, “walking”, “handwashing”, or “hair combing”.

With reference to FIG. 1, the determination part 322 determines whether or not the resulting output by the second trained model 331, i.e., action information indicative of the action estimated by the second estimation part 321 is wrong, and inputs determination result information indicative of a determination result to the second estimation part 321. The determination result information is determination result information indicating that the estimation of the action is correct or determination result information indicating that the estimation of the action is wrong.

The determination part 322 inputs to the device 4 a control signal for controlling the device 4 according to the action estimated by the second estimation part 321 through the communication device 31, and determines, when acquiring from the device 4 a cancellation order of the control indicated by the control signal within a reference period after the input through the communication device 31, that the resulting output is wrong, and inputs determination result information indicative of wrongness to the second estimation part 321; on the other hand, the determination part 322 inputs, when not acquiring the cancellation order within the reference period after the input of the control signal to the device 4, determination result information indicative of correctness to the second estimation part 321. The control signal output by the determination part 322 indicates a control predetermined according to the estimated action.

The second estimation part 321 acquires, when receiving an input of determination result information indicating that the resulting output is correct, output sound information corresponding to the resulting output from the memory 33, and retrains the second trained model 331 using the acquired output sound information.

For example, if the user inputs to the device 4 an order of changing the control thereof within the reference period after the device 4 operates on the basis of the control signal according to the estimated action, it is highly probable that the action is estimated wrongly. In this case, the device 4 outputs to the server 3 a cancellation order for notifying the server 3 of the cancellation of the control. The determination part 322 that has received an input of the cancellation order determines that the action corresponding to the cancellation order is misestimated. Since an identical identifier is assigned to output sound information input to the server 3, sound information from which the output sound information originates, action information indicative of an action estimated from the output sound information, a control signal generated according to the action information, and a cancellation order of the control signal, the determination part 322 can specify pieces of information associated with each other among these pieces of information.

The control of the device 4 differs according to the type of the device 4 and the estimated action. For example, in a case where the device 4 is a lighting device and the estimated action is “walking”, a control of turning on the lighting device is executed. For example, in a case where the device 4 is a hair dryer and the estimated action is “hair combing”, a control of activating the hair dryer is executed. For example, in a case where the device 4 is a lighting device in the washroom and the estimated action is “handwashing”, a control of turning on the lighting device in the washroom is executed. For example, in a case where the device 4 is an air conditioner and the estimated action is “walking”, a control of activating the air conditioner is executed.

The memory 33 includes a storage device that is non-volatile and rewritable, e.g., a hard disk drive or a solid state drive, and stores the second trained model 331 and the information input to the second trained model 331 such as the output sound information. The output sound information is stored in association with the determination result information.

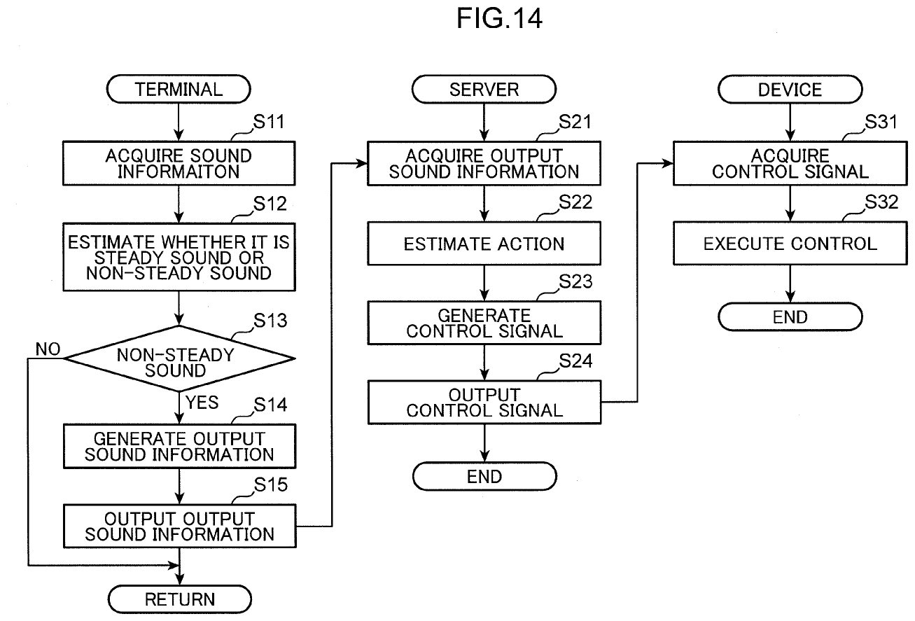

The configuration of the server 3 is as described above. Next, the process of the information processing system 1 will be described. FIG. 14 is a flowchart showing an exemplary process of the information processing system 1 according to the first embodiment of the present disclosure. The process in the terminal 2 is executed repeatedly. In Step S11, the first estimation part 221 performs AD conversion of a sound signal input from the microphone 21 to acquire sound information having a certain time length.

In Step S12, the first estimation part 221 inputs the sound information to the first trained model 241, and estimates whether the input sound information indicates the steady sound or the non-steady sound. In a case where the first trained model 241 is the autoencoder 500, the first estimation part 221 estimates whether it indicates the steady sound or the non-steady sound by comparing the estimation error between the sound information input to the first trained model 241 and the sound information output from the first trained model 241 with a threshold.

In a case where the first estimation part 221 estimates that the input sound information indicates the non-steady sound in Step S13 (YES in Step S13), it generates output sound information from the input sound information (Step S14).

On the other hand, in a case where it is estimated that the input sound information indicates the steady sound (NO in Step S13), the process returns to Step S11.

In Step S15, the first estimation part 221 outputs the output sound information to the server 3 through the communication device 23.

In Step S21, the communication device 31 acquires the output sound information. In Step S22, the second estimation part 321 inputs the output sound information to the second trained model 331 to estimate an action of the user. In Step S23, the determination part 322 generates a control signal according to the action estimated by the second estimation part 321. In Step S24, the determination part 322 outputs the control signal to the device 4 through the communication device 31.

In Step S31, the device 4 acquires the control signal. In Step S32, the device 4 operates according to the control signal.

Thus, the device 4 is controlled according to the action estimated by the server 3, as shown in the flowchart of FIG. 14.

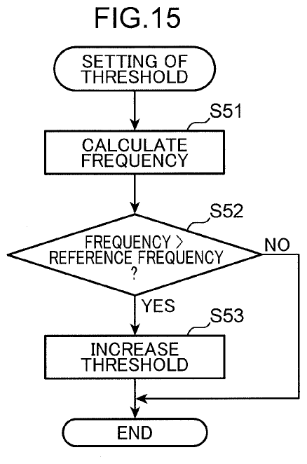

FIG. 15 is a flowchart showing an exemplary setting process of the threshold used in a determination by the terminal 2 of the steady sound or the non-steady sound. This process in the flowchart is executed, for example, at a certain interval. The certain interval is, e.g., an hour, six hours, or a day, but is not particularly limited.

In Step S51, the first estimation part 221 calculates frequency of outputs of output sound information. The first estimation part 221 calculates the frequency using log information, the log information being stored in the memory 24 and indicating that an estimation result of sound information indicates the steady sound or the non-steady sound. The frequency is defined as, for example, the total number of pieces of sound information indicative of the non-steady sound relative to the total number of pieces of sound information input to the first trained model 241 during a period from the previous calculation of frequency to the present. An exemplary data structure of the log information is such that a time of an estimation, a result of the estimation, and an identifier of the sound information are associated with each other.

In Step S52, the first estimation part 221 determines whether or not the frequency is not less than a reference frequency. In a case where the frequency is not less than the reference frequency (YES in Step S52), the first estimation part 221 increases the threshold by a certain value (Step S53). On the other hand, in a case where the frequency is less than the reference frequency (NO in Step S52), the process ends. A value for the reference frequency is predetermined in consideration of the load on the network. Thus, the threshold is increased by the certain value if the frequency is not less than the reference frequency; therefore, the number of times of estimations of the non-steady sound for sound information is gradually reduced, and the number of times of outputs of output sound information is gradually reduced. Consequently, the frequency comes closer and closer to the reference frequency.

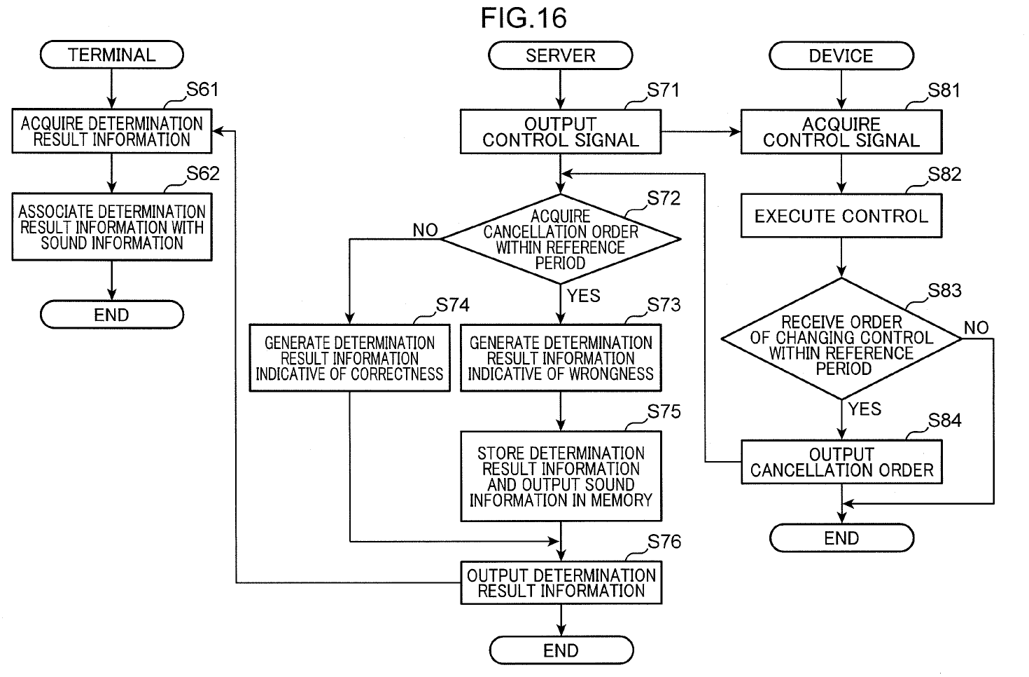

FIG. 16 is a flowchart showing an exemplary process of the information processing system 1 in transmission by the server 3 of a control signal to the device 4.

In Step S71, the determination part 322 generates a control signal according to the action estimated by the second estimation part 321, and outputs the generated control signal to the device 4 through the communication device 31.

In Step S81, the device 4 acquires the control signal. In Step S82, the device 4 executes a control indicated by the control signal. In Step S83, the device 4 determines whether or not it has received an order from the user of changing the control within a reference period after the execution of the control. In a case where the device 4 has received the order within the reference period (YES in Step S83), it generates a cancellation order and outputs the generated cancellation order to the server 3 (Step S84). On the other hand, in a case where it has not received the order within the reference period (NO in Step 83), the process ends.

In Step S72, the determination part 322 of the server 3 determines whether or not it has acquired the cancellation order within the reference period after the output of the control signal. In a case where the determination part 322 has acquired the cancellation order within the reference period (YES in Step S72), it generates determination result information indicating that the estimation of the action by the second estimation part 321 is wrong (Step S73). On the other hand, in a case where the determination part 322 has acquired no cancellation order within the reference period (NO in Step S72), it generates determination result information indicating that the estimation of the action by the second estimation part 321 is correct (Step S74).

In Step S75, the second estimation part 321 stores the determination result information and the output sound information relevant to the determination result information in association with each other in the memory 33.

In Step S76, the second estimation part 321 transmits the determination result information to the terminal 2 through the communication device 31.

In Step S61, the first estimation part 221 of the terminal 2 acquires the determination result information through the communication device 23. In Step S62, the first estimation part 221 associates the determination result information with sound information that is stored in the memory 24 and relevant to the determination result information. The first estimation part 221 can thereby acquire feedback concerning whether or not the action of the user has been correctly estimated from the sound information indicative of the non-steady sound transmitted to the server 3 as the output sound information.

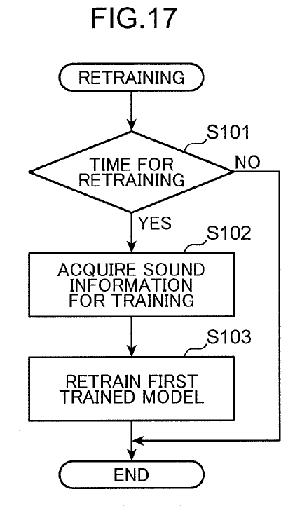

FIG. 17 is a flowchart showing an exemplary process of retraining the first trained model 241. In Step S101, the first estimation part 221 of the terminal 2 determines whether or not it is time for retraining. The time for the retraining is, e.g., a time when a certain period of time elapses after the previous retraining, or a time when the amount of the sound information accumulated in the memory 24 is increased by a predetermined amount after the previous retraining. The time for the first retraining is, e.g., a time when the certain period of time elapses after the start of the operation of the terminal 2, or a time when the amount of the sound information accumulated in the memory 24 is increased by the predetermined amount after the start of the operation of the terminal 2.

In a case where it is time for the retraining (YES in Step S101), the first estimation part 221 acquires sound information for the training from the memory 24 (Step S102). In a case where the first trained model 241 is the autoencoder 500, the sound information for the training is, e.g., sound information estimated to indicate the steady sound, among additional sound information that is additionally accumulated after the previous retraining (or after the start of the operation of the terminal 2) in the memory 24. In a case where the first trained model 241 is the convolutional neural network, the sound information for the training is, e.g., sound information estimated to indicate the steady sound, among the additional sound information, and sound information estimated to indicate the non-steady sound and is associated with the determination result information indicative of the correctness, among the additional sound information.

On the other hand, in a case where it is not time for the retraining (NO in Step S101), the process ends.

In Step S103, the first estimation part 221 retrains the first trained model 241 using the sound information for the training. In a case where the first trained model 241 is the autoencoder 500, the first trained model 241 is retrained by use of the sound information estimated to indicate the steady sound. In a case where the first trained model 241 is the convolutional neural network, the retraining is executed after the sound information estimated to indicate the steady sound is assigned with a label of the steady sound and the sound information that is indicative of the non-steady sound and associated with the determination result information indicative of the correctness is assigned with a label of the non-steady sound.

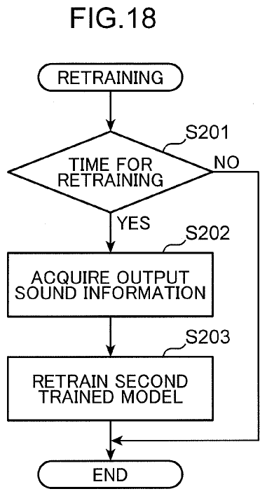

FIG. 18 is a flowchart showing an exemplary process of retraining the second trained model 331. In Step S201, the second estimation part 321 of the server 3 determines whether or not it is time for retraining. The time for the retraining is, e.g., a time when a certain period of time elapses after the previous retraining, or a time when the amount of the output sound information accumulated in the memory 33 is increased by a predetermined amount after the previous retraining. The time for the first retraining is, e.g., a time when the certain period of time elapses after the start of the operation of the server 3, or a time when the amount of the output sound information accumulated in the memory 33 is increased by the predetermined amount after the start of the operation of the server 3.

In a case where it is time for the retraining (YES in Step S201), the second estimation part 321 acquires output sound information for the training from the memory 33 (Step S202). The output sound information for the training is, e.g., sound information associated with the determination result information indicative of the correctness, among additional output sound information that is accumulated after the previous retraining (or after the start of the operation of the server 3) in the memory 33.

On the other hand, in a case where it is not time for the retraining (NO in Step S201), the process ends.

In Step S203, the second estimation part 321 retrains the second trained model 331 using the output sound information for the training.

Thus, in the information processing system 1 in the first embodiment, the terminal 2 does not output all of the sound information on the sounds collected by the microphone 21 to the server 3, but outputs only the sound information indicative of the non-steady sound to the server 3. Therefore, the amount of data moving across the network 5 decreases, and the load on the network 5 and the loads on the terminal 2 and the server 3 can be reduced.

### Second Embodiment

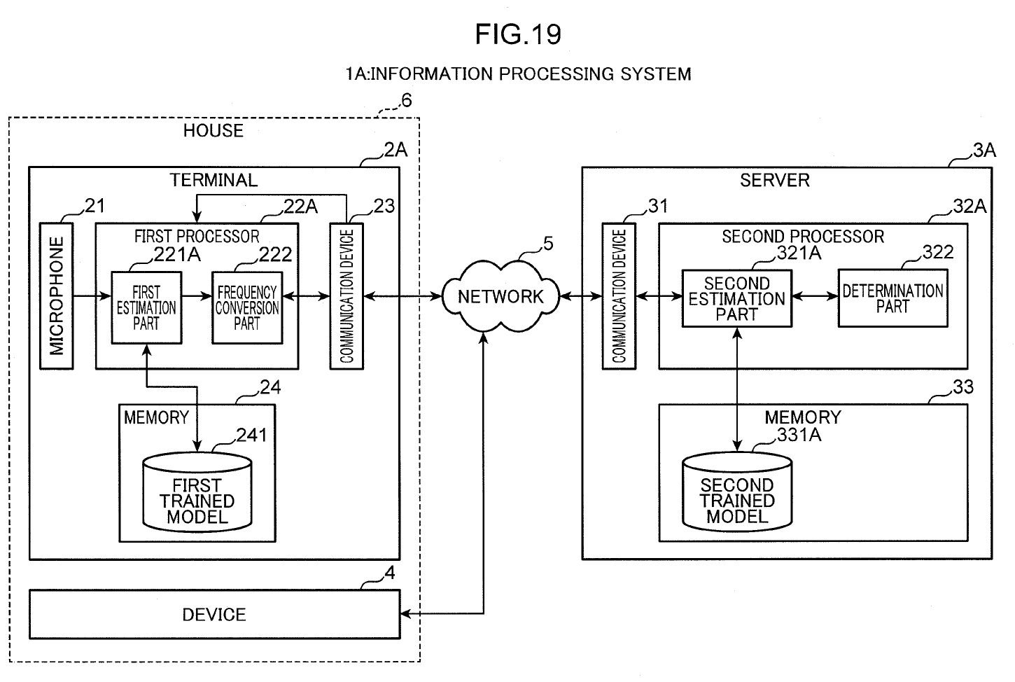

In the second embodiment, the output sound information is generated by converting the frequency band of the sound indicated by the sound information to a lower frequency band. FIG. 19 is a block diagram showing an exemplary structure of an information processing system 1A according to the second embodiment of the present disclosure. In this embodiment, the same constituents as those in the first embodiment are denoted by the same reference numerals, and the description thereof will be omitted.

The first processor 22A of the terminal 2A includes the first estimation part 221A and a frequency conversion part 222. The first estimation part 221A extracts, from the sound information estimated to indicate the non-steady sound among the sound information indicative of the sound collected by the microphone 21, sound information in a first frequency band having a highest sound pressure level, and inputs the extracted sound information in the first frequency band to the frequency conversion part 222. The first frequency band is an ultrasonic band that has a highest sound pressure level among a plurality of predetermined frequency bands.

The frequency conversion part 222 converts the input sound information in the first frequency band to sound information in a second frequency band lower than the first frequency band, the converted sound information in the second frequency band being generated as the output sound information. The frequency conversion part 222 generates accompanying information indicative of a width of the first frequency band to include it in the output sound information.

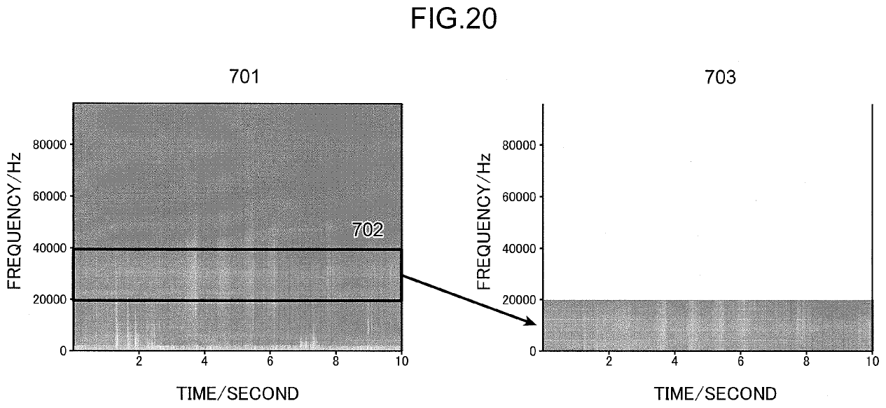

FIG. 20 is a diagram for explaining a frequency conversion. The left graph in FIG. 20 represents sound information 701 indicative of a spectrogram before the frequency conversion. The right graph in FIG. 20 represents sound information 703 indicative of a spectrogram after the frequency conversion. In each of the right and left graphs in FIG. 20, the vertical axis represents the frequency (Hz) and the horizontal axis represents the time (second). The sound information 701 indicates a vertical length of, e.g., 100 kHz, and a horizontal length of, e.g., 10 seconds.

The first estimation part 221A separates the sound information 701 by a predetermined frequency band of 20 kHz. Here, the frequency band of 0 kHz to 100 kHz is separated into five frequency bands by 20 kHz. The first estimation part 221A then specifies the frequency band that has the highest sound pressure level among the four frequency bands in an ultrasonic band of 20 kHz or more. The sound pressure level is, e.g., a total value or an average value of sound pressure in each frequency band. Here, the pixel value of each pixel represents the sound pressure; thus, a total value or an average value of the pixel values in each frequency band is calculated as the sound pressure level. The separation of the sound information 701 by 20 kHz is ascribed to the fact that the hearing range is up to 20 kHz.

In the example of the left graph in FIG. 20, the frequency band of 20 kHz to 40 kHz has the highest sound pressure level among the four frequency bands in the ultrasonic band. Thus, the first estimation part 221A extracts sound information 702 in the frequency band of 20 kHz to 40 kHz from the sound information 701. The ignorance of the frequency band of 0 to 20 kHz is ascribed to the fact that this frequency band is the hearing range and includes many unnecessary noises, causing a decrease in the accuracy in the estimation of the action.

Next, the frequency conversion part 222 converts the sound information 702 to sound information 703 in the hearing range of 0 to 20 kHz. The hearing range is an exemplary second frequency band. The sound information 703 is image information including the original distribution of sound pressure indicated by the sound information 702; the sound information 703 indicates the same horizontal length of 10 seconds as the sound information 701, but indicates a reduced vertical length of 20 kHz, from which it can be seen that the amount of data of the sound information 703 is reduced to approximately ⅕ of that of the sound information 701. Additionally, the frequency conversion part 222 generates accompanying information indicative of a width “20 kHz to 40 kHz” of the frequency band of the sound information 702. The frequency conversion part 222 then transmits the sound information 703 and the accompanying information as the output sound information to the server 3 through the communication device 23. Since the sound information 703 is sound information in the hearing range, the sampling rate can be reduced in comparison with the case of transmission of the sound information 702, which enables reduction of the amount of data.

With reference to FIG. 19, the second processor 32A of the server 3A further includes a second estimation part 321A. The memory 33 of the server 3A includes a second trained model 331A.

The second estimation part 321A estimates an action of the user from a resulting output obtained by inputting the sound information 703 and the accompanying information output from the terminal 2 to the second trained model 331A.

The second trained model 331A is a model that has been trained by machine learning with teaching data which is one or more datasets including a set of: the sound information 703 with the accompanying information; and an action associated with the sound information 703.

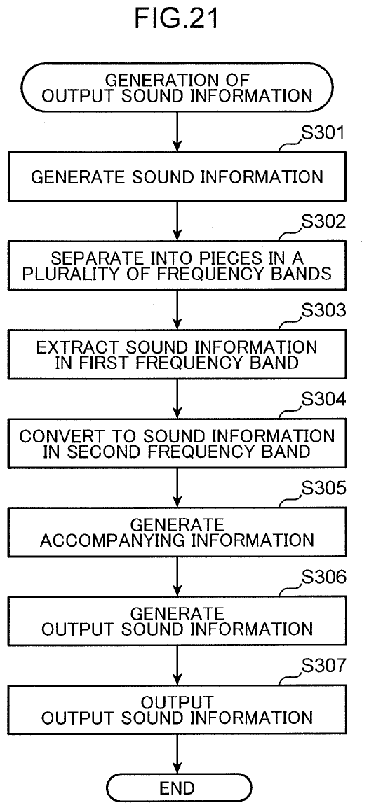

The configuration of the information processing system 1A is as described above. Next, the frequency conversion by the terminal 2 will be described. The frequency conversion by the terminal 2 is a subroutine of the generation of the output sound information shown in Step S14 in FIG. 14. Therefore, the frequency conversion by the terminal 2 will be described as the subroutine of Step S14. FIG. 21 is a flowchart showing in detail an exemplary process in Step S14 in FIG. 14 in the second embodiment of the present disclosure.

In Step S301, the first estimation part 221A generates sound information 701 indicative of a feature of a sound in sound information estimated to indicate the non-steady sound.

In Step S302, the first estimation part 221A separates the sound information 701 into pieces in a plurality of frequency bands.

In Step S303, the first estimation part 221A extracts sound information 702 in a first frequency band that is in an ultrasonic band and has the highest sound pressure level among the plurality of separated frequency bands.

In Step S304, the frequency conversion part 222 converts the sound information 702 to sound information 703 in a second frequency band (the hearing range).

In Step S305, the frequency conversion part 222 generates accompanying information indicative of a width of the first frequency band.

In Step S306, the frequency conversion part 222 generates output sound information including the sound information 703 and the accompanying information.

In Step S307, the frequency conversion part 222 transmits the output sound information to the server 3A through the communication device 23.

As described above, in the information processing system 1A in the second embodiment, sound information in a first frequency band concerning the non-steady sound is extracted from the sound information indicative of the sound collected by the microphone 21, the extracted sound information is converted to sound information in a second frequency band lower than the first frequency band, and the converted sound information in the second frequency band is output from the terminal 2 to the server 3. Thus, the amount of data of the sound information transmitted to the network 5 can be greatly reduced in comparison with a case where chronological data of the sound collected by the microphone 21 is transmitted.

In the example in FIG. 20, the sound information 701 is separated by 20 kHz, but the separation is not limited to by 20 kHz, and may be by an appropriate value, e.g., by 1, 5, 10, 30, or 50 kHz. In the example in FIG. 20, the sound information 701 indicates a vertical length of 100 kHz, but this is merely an example; an appropriate value, e.g., 200, 500, or 1000 kHz can be used. In the example in FIG. 20, the sound information 701 indicates a horizontal length of 10 seconds, but this is merely an example; an appropriate value, e.g., 1, 3, 5, 8, 20, or 30 seconds can be used.

The frequency conversion part 222 converts the frequency using the sound information 701 indicative of the spectrogram, but the present disclosure is not limited to this; it may perform the frequency conversion of image information indicative of a frequency response of a sound indicated by sound information or perform the frequency conversion of the frequency response of the sound indicated by the sound information.

### Third Embodiment

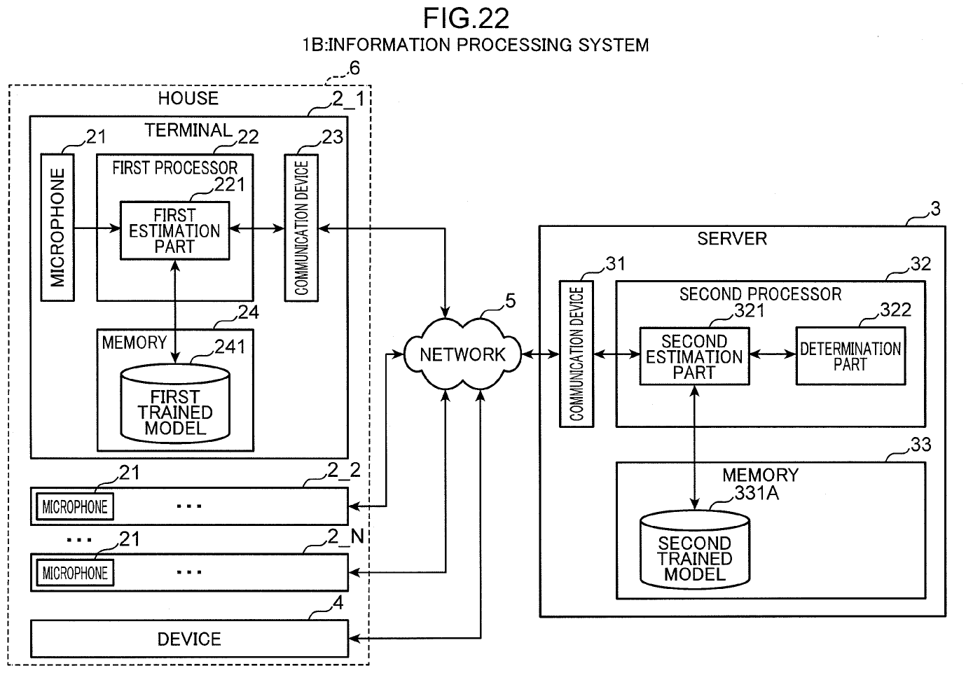

In the third embodiment, the house 6 is provided with a plurality of terminals 2. FIG. 22 is a block diagram showing an exemplary structure of an information processing system 1B according to the third embodiment of the present disclosure. In this embodiment, the same constituents as those in the first and second embodiments are denoted by the same reference numerals, and the description thereof will be omitted. The house 6 is provided with N terminals 2 (N is an integer of 2 or more), e.g., terminals 2_1, 2_2, . . . , 2_N. The terminals 2 are disposed in places of the house 6 where it is necessary to monitor an action, e.g., one terminal in each room.

Since the configurations of the terminal 2_2 to the terminal 2_N in FIG. 22 are the same as the configuration of the terminal 2_1, the details of the configurations are omitted.

Each terminal 2 independently collects a sound with a microphone 21, and generates, in a case where the collected sound is the non-steady sound, output sound information from the sound information thereon and transmits the generated output sound information to the server 3.

The second estimation part 321 of the server 3 inputs the output sound information transmitted from each terminal 2 to the second trained model 331, and individually estimates an action of the user from each piece of the output sound information.

Thus, in the information processing system 1B in the third embodiment, the house 6 is provided with a plurality of terminals 2, which enables estimation of an action of a user wherever in the house 6 the user is. The terminal 2 in FIG. 22 has the same configuration as that in the first embodiment, but may have the same configuration as that in the second embodiment.

### Fourth Embodiment

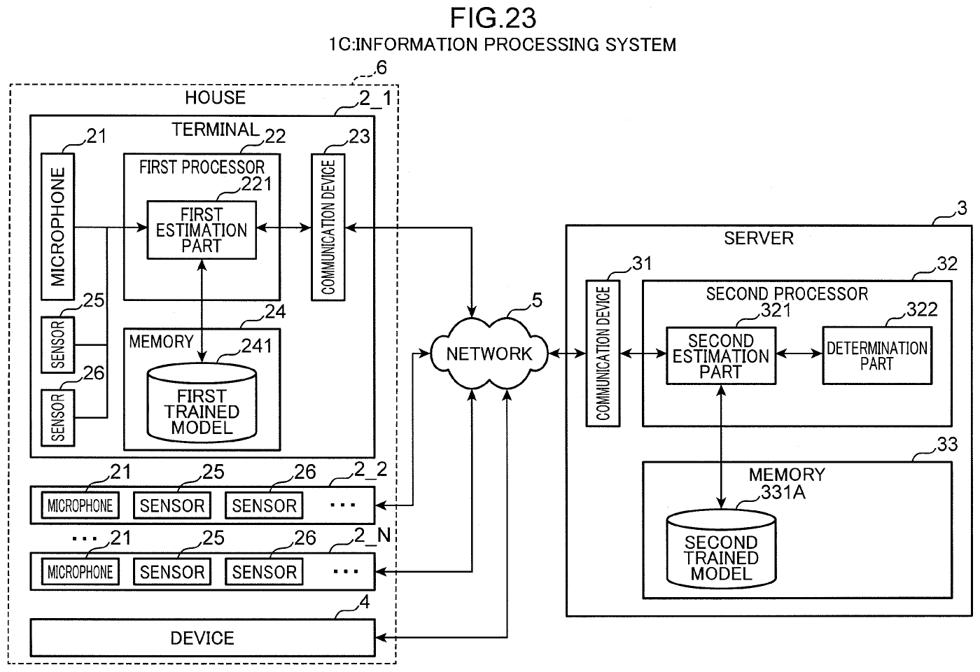

In the fourth embodiment, each terminal 2 in the configuration of the third embodiment is provided with one or more sensors in addition to the microphone 21. FIG. 23 is a block diagram showing an exemplary structure of an information processing system 1C according to the fourth embodiment of the present disclosure. In this embodiment, the same constituents as those in the first to third embodiments are denoted by the same reference numerals, and the description thereof will be omitted.

Each terminal 2 further includes a sensor 25 and a sensor 26. The sensor 25 is a CO₂ sensor that detects concentration of carbon dioxide, a humidity sensor, or a temperature sensor. The sensor 26 is a CO₂ sensor, a humidity sensor, or a temperature sensor, but is different from the sensor 25.

The sensor 25 performs sensing periodically, and inputs first sensing information having a certain time length to the first estimation part 221. The sensor 26 performs sensing periodically, and inputs second sensing information having a certain time length to the first estimation part 221.

The first estimation part 221 inputs the sound information, the first sensing information, and the second sensing information to the first trained model 241 to estimate whether the house 6 is in a steady state or a non-steady state. The steady state means a state where no particular action is performed by the user. The non-steady state means a state where a certain action is performed by the user.

The first estimation part 221 inputs the sound information, the first sensing information, and the second sensing information to the first trained model 241 to estimate whether the house 6 is in the steady state or the non-steady state. In a case where the first estimation part 221 estimates that the house 6 is in the steady state, it transmits the sound information, the first sensing information, and the second sensing information as the output sound information to the server 3.

A first trained model 241 constituted by the autoencoder 500 is trained by machine learning with teaching data which is one or more datasets including a set of sound information indicative of the steady sound, first sensing information indicative of the steady state, and second sensing information indicative of the steady state. A first trained model 241 constituted by the convolutional neural network 600 is trained by machine learning with teaching data which is one or more datasets including a set of: sound information, first sensing information, and second sensing information; and a label indicative of the steady state or the non-steady state.

The first trained model 241 may consist of three trained models: a first trained model for the sound information; a second trained model for the first sensing information; and a third trained model for the second sensing information. In this case, the first estimation part 221 may estimate that the house 6 is in the non-steady state when at least one of the first to third trained models makes an estimation indicative of the non-steady sound (or the non-steady state).

The second trained model 331 is a model that has been trained by machine learning with one or more datasets including a set of: sound information that is included in output sound information indicative of the non-steady state, first sensing information, and second sensing information; and an action associated with the output sound information.

Thus, the information processing system 1C in the fourth embodiment enables an estimation of an action of a user in consideration of, e.g., the density of carbon dioxide, the temperature, and the humidity, in addition to the sound information.

Modifications

(1) The server 3 is not limited to a cloud server, and may be, for example, a home server. In this case, the network 5 is a local area network.

(2) The terminal 2 may be provided in the device 4.

(3) In the second embodiment, the first estimation part 221A shown in FIG. 19 may extract, from the sound information estimated to indicate the non-steady sound, sound information in a plurality of first frequency bands. The frequency conversion part 222 may convert the sound information in the first frequency bands extracted by the first estimation part 221A to sound information in a second frequency band that is the lowest first frequency band among the first frequency bands, and synthesize the converted sound information pieces in the second frequency band, the synthesized sound information being generated as the output sound information.

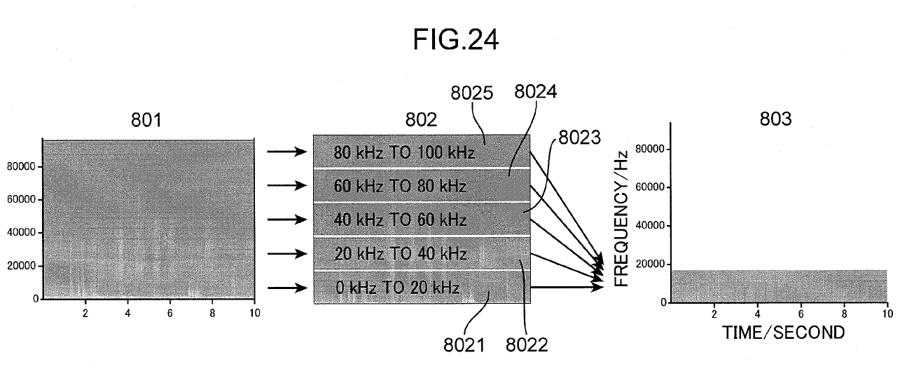

FIG. 24 is a diagram for explaining a third modification of the present disclosure. The left graph in FIG. 24 represents sound information 801 indicative of a spectrogram concerning the non-steady sound before the frequency conversion. The middle graph in FIG. 24 represents sound information 802 indicative of the spectrogram separated according to a plurality of frequency bands. The right graph in FIG. 24 represents sound information 803 indicative of a spectrogram after the frequency conversion. In each of the three graphs in FIG. 24, the vertical axis represents the frequency (Hz) and the horizontal axis represents the time (second).

The first estimation part 221A separates the sound information 801 by a predetermined frequency band of 20 kHz. Here, the frequency band of 0 kHz to 100 kHz is separated into five frequency bands by 20 kHz, so that five pieces of sound information 8021, 8022, 8023, 8024, and 8025 are obtained. The five pieces of sound information 8021 to 8025 represent the sound information in the plurality of first frequency bands.

The frequency conversion part 222 converts the sound information 8021 to 8025 to respective pieces of sound information in the hearing range and combines the five converted pieces of sound information to thereby generate sound information 803. The sound information 803 represents the sound information in the second frequency band. The sound information 803, of which the amount of data is reduced to approximately ⅕ of that of the sound information 801, is thus obtained. The frequency conversion part 222 transmits the sound information 803 as the output sound information to the server 3 through the communication device 23. Since the sound information 803 is sound information in the hearing range, the sampling rate can be reduced in comparison with the case of transmission of the sound information 801, which enables reduction of the amount of data.

The second estimation part 321A of the server 3A estimates an action of the user using the second trained model 331 mentioned in the first embodiment. Specifically, the second estimation part 321A estimates an action of the user from a resulting output obtained by inputting the sound information 803 to the second trained model 331.

(4) In the second embodiment, the first estimation part 221A may extract, from the sound information estimated to indicate the non-steady sound, sound information in a first frequency band concerning the non-steady sound among a plurality of first frequency bands. The frequency conversion part 222 may convert the sound information in the first frequency band extracted by the first estimation part 221A to sound information in a second frequency band that is the lowest first frequency band among the first frequency bands, and synthesize the converted sound information in the second frequency band, the synthesized sound information being generated as the output sound information.

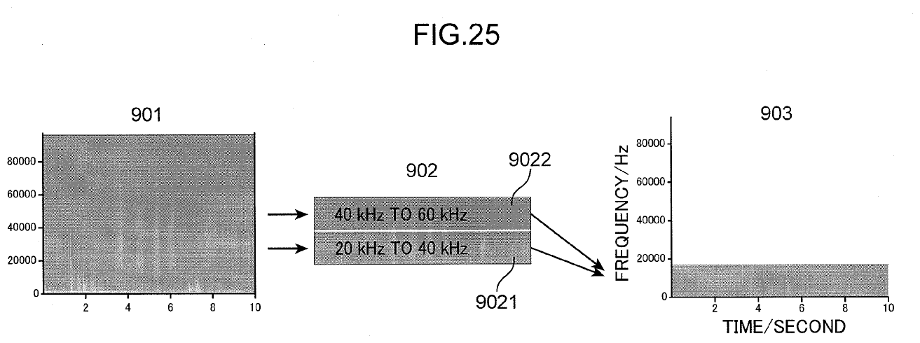

FIG. 25 is a diagram for explaining a fourth modification of the present disclosure. The left graph in FIG. 25 represents sound information 901 indicative of a spectrogram before the frequency conversion. The middle graph in FIG. 25 represents sound information 902 in a frequency band concerning the non-steady sound having a predetermined value or more. The right graph in FIG. 25 represents sound information 903 after the frequency conversion.

The first estimation part 221A separates the sound information 901 by a predetermined frequency band of 20 kHz, and extracts sound information 902 in a frequency band that indicates a predetermined value or more for the sound pressure level among the separated frequency bands. Here, the extracted sound information 902 includes sound information 9021 in a frequency band of 20 kHz to 40 kHz and sound information 9022 in a frequency band of 40 kHz to 60 kHz. The sound pressure level is represented by the total value or the average value of the sound pressure in each frequency band, similarly to the second embodiment.

Further, the first estimation part 221A generates accompanying information indicative of the frequency band (20 kHz to 40 kHz) of the extracted sound information 9021 and the frequency band (40 kHz to 60 kHz) of the extracted sound information 9022.

The frequency conversion part 222 converts the sound information 9021 and the sound information 9022 to respective pieces of sound information in the hearing range of 0 to 20 kHz and combines the two converted pieces of sound information to thereby generate sound information 903. The frequency conversion part 222 then transmits the sound information 903 and the accompanying information as the output sound information to the server 3A through the communication device 23.

The second estimation part 321A of the server 3A estimates an action of the user using the second trained model 331A mentioned in the second embodiment. Specifically, the second estimation part 321A estimates an action of the user from a resulting output obtained by inputting the sound information 903 and the accompanying information to the second trained model 331A.

(5) The way of frequency conversion by the frequency conversion part 222 is not particularly limited; for example, a trigonometric addition formula shown in the equation below can be used.

sin α·cos β=(1/2)·(sin(α+β)+sin(α−β))

For example, in a case where a sound signal in a frequency band of 20 kHz to 40 kHz is converted to that in a frequency band of 0 kHz to 20 kHz, the frequency conversion part 222 can perform the frequency conversion by multiplying the sound signal in the frequency band of 20 kHz to 40 kHz with a sound signal at 20 kHz and extracting the differential component (sin(α−β)).

### INDUSTRIAL APPLICABILITY

The present disclosure is useful as a technique of estimating an action of a user and controlling a device on the basis of the estimated action.

1. An information processing system comprising a terminal and a computer connected with each other via a network, wherein
the terminal includes:
a sound collector that collects a sound; and
a first estimator that inputs sound information indicative of the collected sound to a first trained model to estimate whether the sound indicated by the sound information is steady sound or non-steady sound, and outputs to the computer via the network the sound information estimated to indicate the non-steady sound as output sound information when the sound information is estimated to indicate the non-steady sound, and
the computer includes:
an acquisition part that acquires the output sound information; and
a second estimator that estimates an action of a person from a resulting output obtained by inputting the output sound information acquired by the acquisition part to a second trained model indicative of a relevance between the output sound information and action information on an action of a person.

2. The information processing system according to claim 1, wherein the output sound information is image information indicative of a spectrogram or frequency response of the sound collected by the sound collector.

3. The information processing system according to claim 1, wherein the first estimator extracts, from the sound information estimated to indicate the non-steady sound, sound information in a first frequency band having a highest sound pressure level, and converts the extracted sound information in the first frequency band to sound information in a second frequency band lower than the first frequency band, the converted sound information in the second frequency band being generated as the output sound information.

4. The information processing system according to claim 3, wherein the output sound information has accompanying information indicative of a width of the first frequency band.

5. The information processing system according to claim 3, wherein the second trained model has learned by machine learning a relevance between the sound information in the second frequency band and having the accompanying information and the action information.

6. The information processing system according to claim 3, wherein the first frequency band is an ultrasonic band that has a highest sound pressure level among a plurality of predetermined frequency bands.

7. The information processing system according to claim 1, wherein the first estimator estimates the sound indicated by the sound information to be the non-steady sound when an estimation error of the first trained model is not less than a threshold, and changes the threshold such that a frequency of estimations of the non-steady sound is not greater than a reference frequency.

8. The information processing system according to claim 1, further comprising:
a determination part that determines whether or not the resulting output from the second trained model is wrong, and inputs determination result information indicative of a result of the determination to the second estimator, wherein
the second estimator retrains, when receiving an input of determination result information indicating that a resulting output is correct, the second trained model using output sound information corresponding to the resulting output.

9. The information processing system according to claim 8, wherein the determination part inputs to a device a control signal of controlling the device according to the action information indicative of the action estimated by the second estimator, and determines that the resulting output is wrong when receiving from the device a cancellation order of the control indicated by the control signal.

10. The information processing system according to claim 8, wherein the second estimator outputs, when receiving an input of the determination result information, the determination result information to the terminal via the network.

11. The information processing system according to claim 1, wherein the first estimator retrains the first trained model by using the sound information estimated to indicate the steady sound by the first trained model.

12. The information processing system according to claim 1, wherein the sound information concerns sound information on an ambient sound in a space where the sound collector is disposed.

13. The information processing system according to claim 1, wherein the sound information acquired by the sound collector includes a sound in an ultrasonic band.

14. The information processing system according to claim 1, wherein the first estimator extracts, from the sound information estimated to indicate the non-steady sound, sound information in a plurality of first frequency bands, converts the extracted sound information in the first frequency bands to sound information in a second frequency band that is the lowest first frequency band among the first frequency bands, and synthesizes the converted sound information pieces in the second frequency band, the synthesized sound information being generated as the output sound information.

15. The information processing system according to claim 1, wherein the first estimator extracts, from the sound information estimated to indicate the non-steady sound, sound information in a first frequency band concerning the non-steady sound among a plurality of first frequency bands, converts the extracted sound information in the first frequency band to sound information in a second frequency band that is the lowest first frequency band among the first frequency bands, and synthesizes the converted sound information in the second frequency band, the synthesized sound information being generated as the output sound information.

16. An information processing method for use in an information processing system including a terminal and a computer connected to each other via a network, comprising:
by the terminal,
collecting a sound;
inputting sound information indicative of the collected sound to a first trained model to estimate whether the sound indicated by the sound information is steady sound or non-steady sound; and
outputting to the computer via the network the sound information estimated to indicate the non-steady sound as output sound information when the sound information is estimated to indicate the non-steady sound, and
by the computer,
acquiring the output sound information; and
estimating an action of a person from a resulting output obtained by inputting the acquired output sound information to a second trained model indicative of a relevance between the output sound information and action information on an action of a person.

17. A non-transitory computer readable recording medium an information processing program for use in an information processing system including a terminal and a computer connected to each other via a network, the information processing program
causing the terminal to execute a process of:
collecting a sound;
inputting sound information indicative of the collected sound to a first trained model to estimate whether the sound indicated by the sound information is steady sound or non-steady sound; and
outputting to the computer via the network the sound information estimated to indicate the non-steady sound as output sound information when the sound information is estimated to indicate the non-steady sound, and
causing the computer to execute a process of:
acquiring the output sound information; and
estimating an action of a person from a resulting output obtained by inputting the acquired output sound information to a second trained model indicative of a relevance between the output sound information and action information on an action of a person.
